(19) United States
(12) Patent Application Publication
(10) Pub. No.: US 2014/0007148 A1
(43) Pub. Date: Jan. 2, 2014

(54) SYSTEM AND METHOD FOR ADAPTIVE DATA PROCESSING

(71) Applicants: Joshua J. Ratliff, San Jose, CA (US); Kenton M. Lyons, Santa Clara, CA (US)

(72) Inventors: Joshua J. Ratliff, San Jose, CA (US); Kenton M. Lyons, Santa Clara, CA (US)

(21) Appl. No.: 13/535,923

(22) Filed: Jun. 28, 2012

(51) Int. Cl. H04N 21/25

(52) U.S. Cl. CPC H04N 21/251
USPC 725/12

(57) ABSTRACT

A system and method for adapting data processing of media having video content based, at least in part on, characteristics of a viewer captured from a sensor during presentation of the media to the viewer. During presentation of video content, a sensor may capture a viewer's eye movement and the focus of the viewer's gaze relative to a display upon which the video content is being displayed, wherein regions of the display in which the viewer's gaze is focused may be indicative of viewer interest in corresponding subject matter and regions of the display in which the viewer's gaze is not focused may be indicative of lack of viewer interest in corresponding subject matter. The system is configured to prioritize processing of the media file based, at least in part, on identified regions of interest and non-interest, wherein regions of interest are processed with higher priority than regions of non-interest.

### FIELD

The present disclosure relates to image processing, and, more particularly, to a system and method for adaptive video data processing based on characteristics of a viewer during presentation of the video data.

### BACKGROUND

The presentation of a video on a display generally involves the processing of video data. Video data processing may include, for example, data compression. Data compression may be characterized as the process of encoding source information using an encoding scheme into a compressed form having fewer bits than the original or source information. Different encoding schemes may be used in connection with data compression. One class of data compression techniques is generally known as lossy data compression techniques in which there is some acceptable loss or difference between the original and decompressed forms. Lossy compression techniques may utilize predetermined heuristics based on known properties of the human perceptual system. For example, some compression techniques may include perceptual video compression, which may involve calculating the spatial distribution of bits with close coherence of the perceptually meaningful shapes, objects and actions presented in a scene of a video. Additionally, video compression can be guided by content analysis of specific features of the media content defined a priori to be important, such as, for example, a face of a person in the video.

The lossy compression techniques may disregard the less important information while retaining the other more important information. For example, one viewing a picture may not notice the omission of some finer details of the background. The predetermined heuristics and/or content analysis may indicate that the foregoing background details may be less important and such information about the background details may be omitted from the compressed form.

Although some current video compression techniques exploit redundancy in video data and attempt to pack large amount of information into a small number of samples, current techniques may be limited in function and may thus be inefficient. More specifically, current video compression techniques generally rely on predetermined qualities of the human perceptual system and/or media content analysis and lack the ability to adapt to an individual viewer's perceptual needs, thereby leading to inefficiency in use of computational resources.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 is a block diagram illustrating one embodiment of a system for dynamically processing media based on characteristics of a viewer during presentation of the media consistent with various embodiments of the present disclosure;

FIG. 2 is a block diagram illustrating the system of FIG. 1 in greater detail;

FIG. 3 is a block diagram illustrating one embodiment of a face detection module consistent with various embodiments of the present disclosure;

FIG. 4 is a block diagram illustrating one embodiment of a video data processing module consistent with various embodiments of the present disclosure;

FIG. 5 is a flow diagram illustrating one embodiment for adaptive data processing in accordance with at least one embodiment of the present disclosure.

Although the following Detailed Description will proceed with reference being made to illustrative embodiments, many alternatives, modifications, and variations thereof will be apparent to those skilled in the art.

### DETAILED DESCRIPTION

By way of overview, the present disclosure is generally directed to a system and method for adaptive processing of media including video content based on characteristics of a viewer captured from at least one sensor during presentation of the media to the viewer. More specifically, during presentation of video content, a sensor may capture particular attributes of the viewer, including, but not limited to, a viewer's eye movement and the focus of the viewer's gaze (generally referred to as “foveal vision” or “center of gaze”) relative to a display upon which the video content is being displayed. The region of the display in which the viewer's gaze is focused may be indicative of viewer interest and/or attentiveness to particular subject matter being presented in the region (hereinafter referred to as “region of interest”). The system is configured to identify one or more regions of interest for one or more associated video frames. The system is further configured to identify one or more regions in which the viewer has little or no gaze focus (hereinafter referred to as “region of non-interest”).

The system is configured to manage processing and presentation of the video to the viewer based on identified regions of interest and non-interest. More specifically, the system is configured to prioritize the processing of video based, at least in part, on identified regions of interest and non-interest, wherein indentified regions of interest are processed with higher priority than regions of non-interest.

A system and method consistent with the present disclosure provides adaptive processing (e.g., but not limited to, compressing, rendering and transforming) and presentment of video content to suit an individual viewer's perceptual characteristics, thereby providing improved and intuitive interaction between a viewer and a media device presenting video content to the viewer. The system provides a prioritized means of processing video content, wherein subject matter of more interest to the viewer is processed with higher priority than subject matter of little or no interest to the viewer. Accordingly, the system may efficiently allocate and/or conserve computational resources by optimizing the video processing techniques by focusing on processing video content most likely to be of interest and viewed by the viewer rather than video content that is of little or no interest to the viewer.

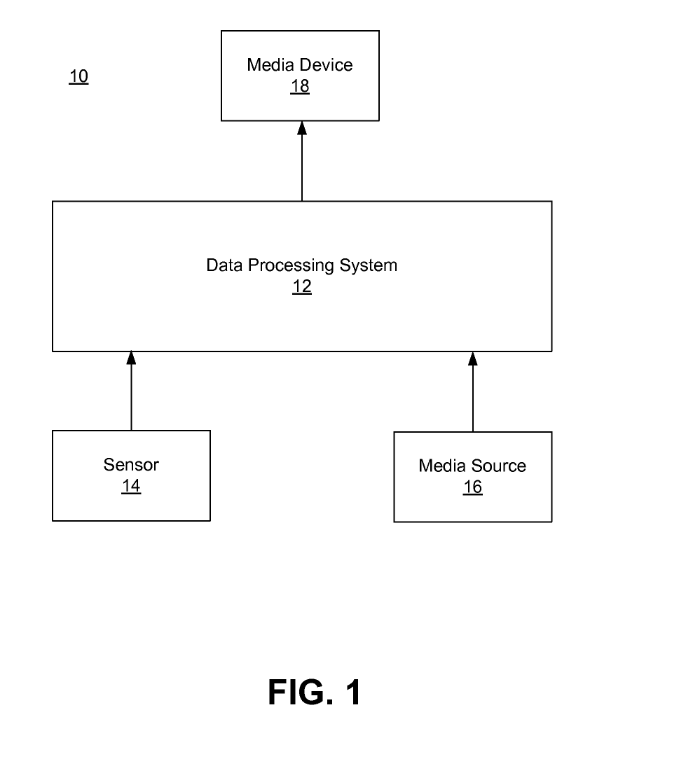

Turning to FIG. 1, one embodiment of a system 10 consistent with the present disclosure is generally illustrated. The system 10 includes a data compressing system 12, at least one sensor 14, a media source 16 and a media device 18. As discussed in greater detail herein, the data processing system 12 is configured to receive data captured from the at least one sensor 14 during presentation of media from the media source 16 on the media device 18. The data processing system 12 is configured to identify at least one characteristic of a viewer during presentation of the media based on the captured data from the at least one sensor 14 and further identify viewer interest with respect to the media based on an identified viewer characteristic. The data processing system 12 is further configured to manage processing and presentation of the media on the media device 18 based, at least in part, on identified viewer interest.

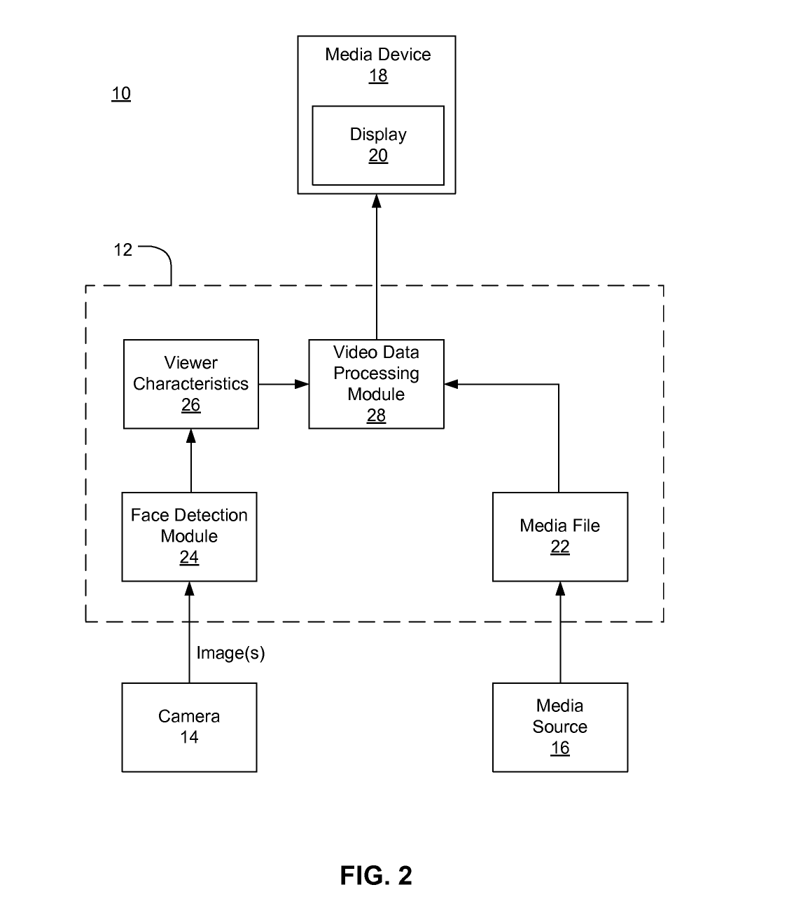

Turning now to FIG. 2, the system 10 of FIG. 1 is illustrated in greater detail. As shown, the data processing system 12 may be configured to receive and process content from the media source 16 for playback on the media device 18. In one embodiment, the data processing system 12 may be configured to receive a media file 22 containing video content from the media source 16. The media source 16 may include a selectable variety of consumer electronic devices, including, but not limited to, a personal computer, a video cassette recorder (VCR), a compact disk/digital video disk device (CD/DVD device), a cable decoder that receives a cable TV signal, a satellite decoder that receives a satellite dish signal, and/or a media server configured to store and provide various types of selectable programming. The media source 16 may provide any known type of information to the data processing system 12, including video, audio, and/or data sources that may be formatted in any compatible or appropriate format.

The media file 22 may include any type of digital media presentable on the media device 18, such as, for example, video content (e.g., movies, television shows) audio content (e.g. music), e-book content, software applications, gaming applications, etc. In the following examples, the adaptation of the data processing of a video file is described herein. It should be noted, however, that systems and methods consistent with the present disclosure also include the dynamic adaptation of other visual media, such as, for example, live television signals, e-books, video games, etc.

The media device 18 may be configured to provide video and/or audio playback of content from data processing system 12 to a viewer. For example, content of the media file 22 may be presented to the viewer visually and/or aurally on the media device 18, via a display 20 and/or speakers, for example. The media device 18 may include any type of display 20 including, but not limited to, a television, an electronic billboard, a digital signage, a personal computer (e.g., desktop, laptop, netbook, tablet, etc.), e-book, a mobile phone (e.g., a smart phone or the like), a music player, or the like.

As previously discussed, the data processing system 12 is configured to receive data captured from at least one sensor 14. A system 10 consistent with the present disclosure may include a variety of sensors configured to capture various attributes of a viewer during presentation of a media file 22 on the media device 18, such as physical characteristics of a user that may be indicative of viewer interest and/or attentiveness in regards to content of the media file 22 being displayed. For example, in the illustrated embodiment, the system 10 includes at least one camera 14 configured to capture one or more digital images of a viewer during presentation of the media file 22 on the display 20 of the device 18. The camera 14 includes any device (known or later discovered) for capturing digital images representative of an environment that includes one or more persons, and may have adequate resolution for face analysis of the one or more persons in the environment as described herein.

For example, the camera 14 may include a still camera (i.e., a camera configured to capture still photographs) or a video camera (i.e., a camera configured to capture a plurality of moving images in a plurality of frames). The camera 14 may be configured to capture images in the visible spectrum or with other portions of the electromagnetic spectrum (e.g., but not limited to, the infrared spectrum, ultraviolet spectrum, etc.). The camera 14 may be incorporated within the data processing system 12, media source 16, or media device 18 or may be a separate device configured to communicate with the data processing system 12, media source 16 and/or media device 18 via any known wired or wireless communication. The camera 14 may include, for example, a web camera (as may be associated with a personal computer and/or TV monitor), handheld device camera (e.g., cell phone camera, smart phone camera (e.g., camera associated with the iPhone®, Trio®, Blackberry®, etc.), laptop computer camera, tablet computer (e.g., but not limited to, iPad®, Galaxy Tab®, and the like), e-book reader (e.g., but not limited to, Kindle®, Nook®, and the like), etc. It should be noted that in other embodiments, the system 10 may also include other sensors configured to capture various attributes of the user, such as, for example, one or more microphones configured to capture voice data of the user.

In the illustrated embodiment, the data processing system 12 may include a face detection module 24 configured to receive one or more digital images captured by the camera 14. The face detection module 24 is configured to identify a face and/or face region within the image(s) 22 and, optionally, determine one or more characteristics of the viewer (i.e., viewer characteristics 26). While the face detection module 24 may use a marker-based approach (i.e., one or more markers applied to a user's face), the face detection module 24, in one embodiment, utilizes a markerless-based approach. For example, the face detection module 24 may include custom, proprietary, known and/or after-developed face recognition code (or instruction sets), hardware, and/or firmware that are generally well-defined and operable to receive a standard format image (e.g., but not limited to, a RGB color image) and identify, at least to a certain extent, a face in the image.

The face detection module 24 may also include custom, proprietary, known and/or after-developed facial characteristics code (or instruction sets) that are generally well-defined and operable to receive a standard format image (e.g., but not limited to, a RGB color image) and identify, at least to a certain extent, one or more facial characteristics in the image. Such known facial characteristics systems include, but are not limited to, standard Viola-Jones boosting cascade framework, which may be found in the public Open Source Computer Vision (OpenCV™) package. As discussed in greater detail herein, viewer characteristics 26 may include, but are not limited to, perceptual characteristics, such as, for example, a viewer's focus of gaze toward the display 20 of the media device 18 (e.g., focus of gaze towards specific regions of the display 20) and a distance between the viewer's face and the display 20 of the media device 18.

Although the face detection module 24 is illustrated as being incorporated within the data processing system 12, it should be noted that in some embodiments, the face detection module 24 may be a separate device configured to communicate with the data processing system 12 via any known wired or wireless communication.

During presentation of the media file 22 on the media device 18, the data processing system 12 may be configured to continuously monitor the viewer and determine viewer characteristics 26, particularly perceptual characteristics, associated with the display 20 of the media device 18 in real-time or near real-time. More specifically, the camera 14 may be configured to continuously capture one or more images of the viewer and the face detection module 24 may continually establish viewer characteristics 26 based on the one or more images.

The data processing system 12 further include a video data processing module 28 configured to analyze the viewer characteristics 26 in response to presentation of video content of the media file 22. The video data processing module 28 may be configured to identify a viewer's interest in and/or attentiveness to one or more regions of the display 20 based, at least in part, on the viewer characteristics 26. As described in greater detail herein, the video data processing module 28 may be configured to identify one or more regions of the display 20 in which the viewer's gaze is focused during associated video frames. The identified region(s) may be indicative of viewer interest in and/or attentiveness to particular subject matter being presented in the identified region(s) (hereinafter referred to as “region of interest”). The video data processing module 28 may further be configured to identify one or more regions of the display 20 in which the viewer has little or no gaze focus (hereinafter referred to as “region of non-interest”).

The video data processing module 28 may further be configured to prioritize the processing of video data based, at least in part, on identified regions of interest and non-interest, as will be described in greater detail herein. As generally understood, processing of video data may include, for example, conversion, compression, rendering, transformation, etc. The video data processing module 28 may be configured to establish a priority level for each identified region of interest and non-interest. The video data processing module 28 may be configured to process video data, wherein indentified regions of interest and non-interest will be processed based, at least in part, on associated priority levels. For example, a region of interest may have a higher priority level than identified regions of non-interest. As such, the video data processing module 28 may be configured to place a greater emphasis on the processing of video data within the region of interest as opposed to the regions of non-interest. As such, the processing of video data during a presentation of the media file 22 may change in accordance with the viewer's perceptual characteristics in regards to subject matter being presented, thereby providing a dynamic adaptation of the presentation of the media file 22 to a viewer's perceptual needs.

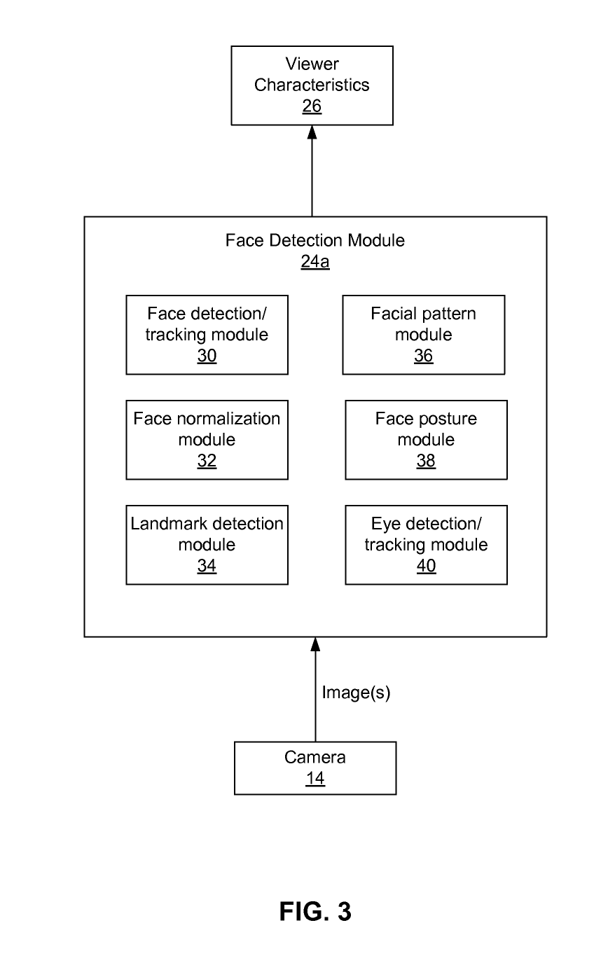

Turning now to FIG. 3, one embodiment of a face detection module 24a consistent with the present disclosure is generally illustrated. The face detection module 24a may be configured to receive one or more images from the camera 14 and identify, at least to a certain extent, a face (or optionally multiple faces) in the image(s). The face detection module 24a may also be configured to identify, at least to a certain extent, one or more facial characteristics in the image(s) and determine one or more viewer characteristics 26. The viewer characteristics 26 may be generated based on one or more of the facial parameters identified by the face detection module 24a as discussed herein. The viewer characteristics 26 may include, but are not limited to, the focus of the viewer's gaze relative to the display 20 of the media device 18 during the presentation of one or more video frames of the video file 22 and the distance between the viewer and the display 20.

For example, one embodiment of the face detection module 24a may include a face detection/tracking module 30, a face normalization module 32, a landmark detection module 34, a facial pattern module 36, a face posture module 38, an eye detection/tracking module 40 and a head tracking module 42. The face detection/tracking module 30 may include custom, proprietary, known and/or after-developed face tracking code (or instruction sets) that is generally well-defined and operable to detect and identify, at least to a certain extent, the size and location of human faces in a still image or video stream received from the camera 14. Such known face detection/tracking systems include, for example, the techniques of Viola and Jones, published as Paul Viola and Michael Jones, Rapid Object Detection using a Boosted Cascade of Simple Features, Accepted Conference on Computer Vision and Pattern Recognition, 2001. These techniques use a cascade of Adaptive Boosting (AdaBoost) classifiers to detect a face by scanning a window exhaustively over an image. The face detection/tracking module 30 may also track a face or facial region across multiple images.

The face normalization module 32 may include custom, proprietary, known and/or after-developed face normalization code (or instruction sets) that is generally well-defined and operable to normalize the identified face in the image(s). For example, the face normalization module 32 may be configured to rotate the image to align the eyes (if the coordinates of the eyes are known), crop the image to a smaller size generally corresponding the size of the face, scale the image to make the distance between the eyes constant, apply a mask that zeros out pixels not in an oval that contains a typical face, histogram equalize the image to smooth the distribution of gray values for the non-masked pixels, and/or normalize the image so the non-masked pixels have mean zero and standard deviation one.

The landmark detection module 34 may include custom, proprietary, known and/or after-developed landmark detection code (or instruction sets) that is generally well-defined and operable to detect and identify, at least to a certain extent, the various facial features of the face in the image(s). Implicit in landmark detection is that the face has already been detected, at least to some extent. Optionally, some degree of localization (for example, a course localization) may have been performed (for example, by the face normalization module 32) to identify/focus on the zones/areas of the image(s) where landmarks can potentially be found. For example, the landmark detection module 34 may be based on heuristic analysis and may be configured to identify and/or analyze the relative position, size, and/or shape of the eyes (and/or the corner of the eyes), nose (e.g., the tip of the nose), chin (e.g. tip of the chin), cheekbones, and jaw. Such known landmark detection systems include a six-facial points (i.e., the eye-corners from left/right eyes, and mouth corners) and six facial points (i.e., green points). The eye-corners and mouth corners may also be detected using Viola-Jones based classifier. Geometry constraints may be incorporated to the six facial points to reflect their geometry relationship.

The facial pattern module 36 may include custom, proprietary, known and/or after-developed facial pattern code (or instruction sets) that is generally well-defined and operable to identify and/or generate a facial pattern based on the identified facial landmarks in the image(s). As may be appreciated, the facial pattern module 36 may be considered a portion of the face detection/tracking module 30.

The face posture module 38 may include custom, proprietary, known and/or after-developed facial orientation detection code (or instruction sets) that is generally well-defined and operable to detect and identify, at least to a certain extent, the posture of the face in the image(s). For example, the face posture module 38 may be configured to establish the posture of the face in the image(s) with respect to the display 20 of the media device 18. More specifically, the face posture module 38 may be configured to determine whether the viewer's face is directed toward the display 20 of the media device 18, thereby indicating whether the user is observing the video file 22 being displayed on the media device 18. Additionally, the face posture module 38 may include custom, proprietary, known and/or after-developed code (or instruction sets) that is generally well-defined and operable to determine a distance between the viewer's face and the display 20 of the media device 18. As described in greater detail herein, one or more parameters associated with processing video data of the video file may be based, at least in part, on the distance between the viewer's face and display 20.

The eye detection/tracking module 40 may include custom, proprietary, known and/or after-developed eye tracking code (or instruction sets) that is generally well-defined and operable to detect and identify eye movement and focus of the viewer's gaze (also referred to as “foveal vision” and “center of gaze”) in the image(s). For the purpose of the present disclosure the terms “foveal vision” and “center of gaze” are interchangeably used to refer to the part of the visual field that is produced by the fovea of the retina in a human eye. As may be understood, the fovea is a portion of the macula of a human eye. In a healthy human eye, the fovea typically contains a high concentration of cone shaped photoreceptors relative to regions of the retina outside the macula. This high concentration of cones can allow the fovea to mediate high visual acuity. As described in greater detail herein, the eye detection/tracking module 40 may be configured to establish the direction in which the viewer's eyes are positioned and track movement of the viewer's eyes with respect to the display 20 of the media device 18. Additionally, the eye detection/tracking module 40 may be configured to determine the regions of the display 20 upon which the viewer's foveal vision is focused.

The tracking of the viewer's eyes and determination of the regions of the display 20 upon which the viewer's foveal vision is focused may indicate the viewer's interest in the specific subject matter of video content that is being displayed in the identified regions of the one or more video frames of the video file 22. For example, the viewer may be interested in a particular character in a movie. As such, during presentation one or more video frames of the movie, the eye detection/tracking module 40 may track the movement of the viewer's eyes and determine regions of the display 20 upon which the viewer's foveal vision is focused, wherein the regions of the display 20 include the particular character of interest to the viewer.

The face detection module 24a may generate viewer characteristics 26 based on or more of the parameters identified from the image(s). In one embodiment, the face detection module 24a may be configured to generate viewer characteristics 26 on a frame by frame basis as the video file is presented to the viewer, thereby providing a viewer's reaction (e.g., but not limited to, user interest and/or attentiveness) to the content associated with each video frame. For example, the viewer characteristics 26 may include, but are not limited to, viewer's eye movement and foveal vision relative to the display 20 during presentation of one or more video frames of the video file 22, as well as the distance between the viewer and display 20. As described in greater detail herein, the viewer characteristics 26 are used by the video data processing module 28 to identify regions of interest and regions of non-interest associated with content of one or more video frames and prioritize video data processing based on the identified regions of interest and non-interest.

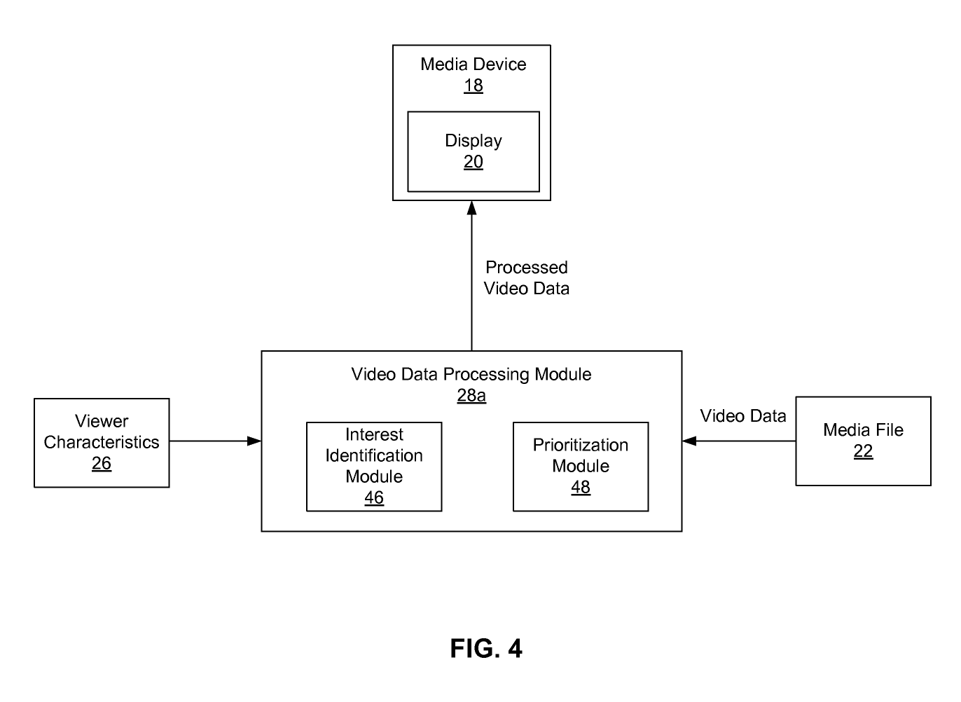

Turning now to FIG. 4, one embodiment of a video data processing module 28a consistent with the present disclosure is generally illustrated. The video data processing module 28a is configured to analyze the viewer characteristics 26 in response to presentation of one or more video frames of the video file 22 to the viewer. The video data processing module 28a is further configured to adaptively process video data based, at least in part, on the viewer characteristics 26.

The video data processing module 28a may be configured to receive and process video data from the video file 22 and transmit processed video data to the media device 18 for presentation to the viewer. In the following description, the video data processing module 28a will be described with reference to data compression of the video data. It should be noted, however, that the video data processing module 28a may be configured to perform various forms of data processing, including, but not limited to, data conversion, data compression, data rendering and data transformation.

As generally understood, the video data processing module 28a may include any known software and/or hardware configured to perform video compression and/or decompression. For example, the video data processing module 28a may include custom, proprietary, known and/or after-developed video compression algorithms, code, or instruction sets that are generally well-defined and operable to perform video compression and/or decompression. The video data processing module 28a may also include a custom, proprietary, known and/or after-developed video compression codec.

In the illustrated embodiment, the video data processing module 28a includes an interest identification module 46 and a prioritization module 48. The interest identification module 46 may be configured to indentify a viewer's interest and/or attentiveness to particular subject matter of video content of one or more video frames of the video file 22 based, at least in part, on the viewer characteristics 26. More specifically, the interest identification module 46 may be configured to identify subject matter of the video content corresponding to one or more identified regions of interest and/or non-interest based on the viewer's perceptual characteristics, such as, for example, the viewer's eye movement and foveal vision relative to the display 20 during presentation of the video file 22.

The interest identification module 46 may include custom, proprietary, known and/or after-developed detection code (or instruction sets) that is generally well-defined and operable to detect and identify, at least to a certain extent, subject matter of one or more video frames that corresponds to one or more identified regions of interest and/or non-interest during presentation of the one or more video frames. For example, in one embodiment, during presentation of the video file 22, a viewer's perceptual characteristics (e.g. eye movement, foveal vision, etc.) may be captured and time synchronized with the video file 22, such that the interest identification module 46 may be configured to identify subject matter of the video content corresponding to the identified regions of interest and non-interest for one or more video frames. More specifically, the interest identification module 46 may be configured to identify subject matter (e.g., a particular character's face) that is within the viewer's region of interest, thereby indicating the viewer's interest in and/or attentiveness to that subject matter. The interest identification module 46 may be further configured to identify subject matter (e.g. background scenery) that is outside of the viewer's region of interest and within the viewer's region of non-interest, thereby indicating the viewer's lack of interest in and/or attentiveness to that subject matter.

Upon identifying subject matter corresponding to regions of interest and/or non-interest, the prioritization module 48 may be configured to establish a priority level for each identified region of interest and non-interest and the corresponding subject matter for one or more video frames. It should be noted that the video data processing module 28a may include a storage medium configured to store identified regions of interest and non-interest and the corresponding subject matter for one or more video frames of the video file 22. The video data processing module 28a may be configured to process video data of one or more video frames based, at least in part, on priority levels determined by the prioritization module 48. For example, the prioritization module 48 may establish a higher priority level for data related to subject matter within a region of interest and a lower priority level for data related to subject matter within a region of non-interest. The priority level may dictate the manner in which associated data is processed by the video data processing module 28a.

As previously described, the video data processing module 28a may be configured to provide data compression of the video data of the video file 22. It should be noted, however, that the video data processing module 28a may be configured to perform various forms of data processing, including, but not limited to, data conversion, data rendering and data transformation. As described herein, the video data processing module 28a may be configured to perform lossy data compression of video data of the video file 22. As may be understood, the video data processing module 28a may also be configured to perform lossless data compression. As generally understood, during lossy data compression, large amounts of data may be eliminated while being perceptually indistinguishable to a viewer. As in all lossy compression, there is a tradeoff between video quality, cost of processing the compression and decompression, and system requirements. It should be noted that a video data processing module consistent with the present disclosure may be configured to provide on-the-fly compression, as generally understood by one skilled in the art.

Upon establishing priority levels for regions of interest and non-interest and the corresponding subject matter of one or more video frames, the video data processing module 28a may be configured to perform lossy data compression of the video data based, at least in part, on the priority levels, wherein the priority levels may dictate the manner in which associated data is processed. For example, video data related to subject matter within a region of interest may have a higher priority level than video data related to subject matter within a region of non-interest. As such, the video data processing module 28a may be configured to focus the processing of the video data within a region of interest as opposed to video data within regions of non-interest. For example, the video data processing module 28a may be configured to provide high spatial updates to the video data within the region of interest. In one embodiment, processing of video data in a region of interest may include higher pixel sampling than video data in a region of non-interest by use of known techniques, such as, for example, raytracing.

Additionally, the video data processing module 28a may be configured to alter spatial resolution of video data based on the distance between a viewer's face and the display 20. The video data processing module 28a may be configured to determine the effective maximum resolution of the display 20 and alter spatial resolution of the video data to optimize the viewing experience by providing an effective resolution of the video data on the display 20.

As may be appreciated, the video data processing module 28a may be configured to process the video data based on viewer characteristics 26 and at least one of predetermined perceptual heuristics and content analytics.

Upon performing data compression of the video file 22 based on the viewer characteristics 26, the video data processing module 28a may provide a processed (e.g., but not limited to, compressed) version of the video file 22. A system and method consistent with the present disclosure may be configured to provide additional viewer characteristics based on the presentation of the processed version of the video file 22 on the media device 18. Additional viewer characteristics may be used to further improve the viewing pattern of a viewer for subsequent processing of the processed video file.

By utilizing an individual viewer's perceptual characteristics, the processing of video data may be prioritized so as to improve and better adapt the presentation of the video data to suit the perceptual needs of the viewer. As such, the processing of video data in accordance with viewer input (e.g. perceptual characteristics) may provide a dynamic adaptation of the presentation of the media file 22 to a viewer's perceptual needs and provide a more efficient means of utilizing computational resources.

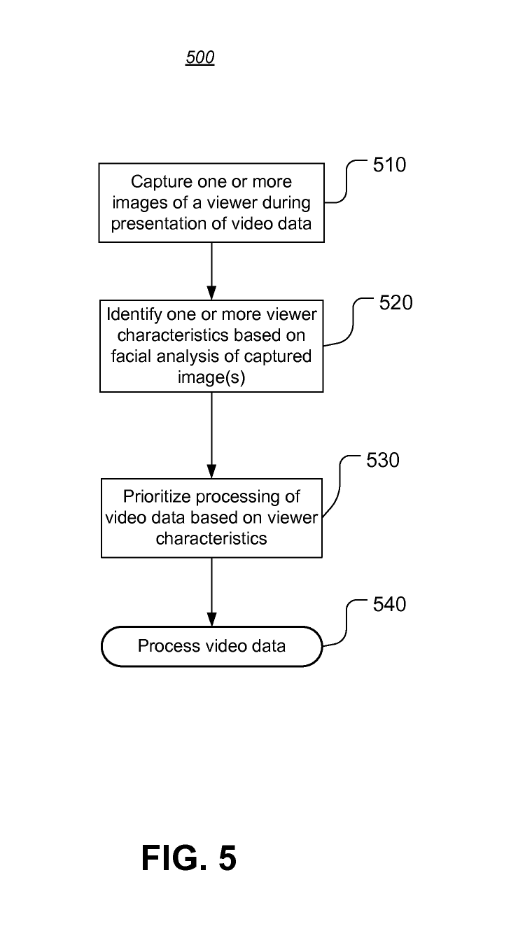

Turning now to FIG. 5, a flowchart of one embodiment of a method 500 for adaptive data processing consistent with the present disclosure is illustrated. The method 500 includes capturing one or more images of a user during presentation of a video file (operation 510). The images may be captured using one or more cameras. A face and/or face region may be identified within the captured image and at least one viewer characteristic may be determined (operation 520). In particular, the image may be analyzed to determine one or more of the following viewer characteristics: the viewer's perceptual characteristics (e.g., gaze toward a display of a media device, gaze towards specific subject matter of content displayed on media device); and distance between viewer's face and the display of the media device.

The method 500 also includes prioritizing processing of video data of the video file based on the viewer characteristics (operation 530). For example, the method 500 may include determining one or more regions of interest and/or non-interest of one or more video frames based on the viewer characteristics and establishing priority levels for each region of interest and on non-interest. Video data may be processed based, at least in part, on the priority levels of the regions of interest and non-interest (operation 540).

While FIG. 5 illustrates method operations according various embodiments, it is to be understood that in any embodiment not all of these operations are necessary. Indeed, it is fully contemplated herein that in other embodiments of the present disclosure, the operations depicted in FIG. 5 may be combined in a manner not specifically shown in any of the drawings, but still fully consistent with the present disclosure. Thus, claims directed to features and/or operations that are not exactly shown in one drawing are deemed within the scope and content of the present disclosure.

Additionally, operations for the embodiments have been further described with reference to the above figures and accompanying examples. Some of the figures may include a logic flow. Although such figures presented herein may include a particular logic flow, it can be appreciated that the logic flow merely provides an example of how the general functionality described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited to this context.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. Thus, the breadth and scope of the present invention should not be limited by any of the above-described exemplary embodiments, but should be defined only in accordance with the following claims and their equivalents.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

According to one aspect, there is provided a system for adaptive video data processing of a video file. The system includes a display for displaying video content of a video file to a viewer. The system further includes a face detection module configured to detect a facial region in an image and identify one or more characteristics of the viewer in the image. The one or more viewer characteristics are associated with video content of one or more video frames of the media file during presentation of the media file to the viewer on the display. The system further includes a data processing system configured to receive data related to the one or more viewer characteristics and process video data of the video file based, at least in part, on the data related to the one or more viewer characteristics.

Another example system includes the foregoing components and the viewer characteristics are selected from the group consisting of eye movement of the viewer relative to the display, focus of eye gaze of the viewer relative to the display and distance between the viewer and the display.

Another example system includes the foregoing components and the face detection module is configured to identify one or more regions of the display as regions of interest and one or more regions of the display as regions of non-interest based, at least in part, on the focus of eye gaze of the viewer relative to the display during presentation of the one or more video frames.

Another example system includes the foregoing components and a region of interest includes a region of the display upon which the viewer's eye gaze is focused and a region of non-interest includes of region of the display upon which the viewer's eye gaze is not focused.

Another example system includes the foregoing components and the data processing system includes an interest identification module configured to indentify subject matter of the one or more video frames corresponding to the one or more regions of interest and the one or more regions of non-interest.

Another example system includes the foregoing components and the data processing system includes a prioritization module configured to establish a priority level for each of the one or more identified regions of interest and non-interest and the corresponding subject matter.

Another example system includes the foregoing components and the prioritization module is configured to establish a higher priority level for video data related to subject matter within a region of interest and establish a lower priority level for data related to subject matter within a region of non-interest.

Another example system includes the foregoing components and the data processing system includes a video data processing module configured to process video data related to subject matter corresponding to the one or more identified regions of interest and non-interest based, at least in part, on the established priority levels.

Another example system includes the foregoing components and the processing of video data related to subject matter corresponding to an identified region of interest includes higher pixel sampling than processing of video data related to subject matter corresponding to an identified region of non-interest.

Another example system includes the foregoing components and the data processing system is further configured to process the video data of the video file based on predetermined perceptual heuristics or video content analytics.

Another example system includes the foregoing components and the processing of video data is selected from the group consisting of compression of the video data, conversion of the video data, rendering of the video data and transformation of the video data.

According to another aspect, there is provided an apparatus for adaptive video data processing of a video file for presentation to a viewer on a display. The apparatus includes a video data processing module configured to receive data related to one or more characteristics of a viewer associated with video content of one or more video frames of the video file during presentation of the video file to the viewer on the display. The video data processing module is configured to process video data of the video file based, at least in part, on the data related to the one or more viewer characteristics.

Another example apparatus includes the foregoing components and the viewer characteristics include at least one of movement of the viewer's eyes relative to the display, focus of the viewer's eye gaze relative to the display and distance between the viewer and the display.

Another example apparatus includes the foregoing components and the viewer characteristics include data related to one or more regions of the display identified as is regions of interest to the viewer and one or more regions of the display identified as is regions of non-interest to the viewer. The one or more regions of interest and non-interest are based, at least in part, on the focus of the viewer's eye gaze relative to the display.

Another example apparatus includes the foregoing components and further including an interest identification module configured to indentify subject matter of the one or more video frames corresponding to the one or more identified regions of interest and the one or more identified regions of non-interest and a prioritization module configured to establish a priority level for each of the one or more identified regions of interest and non-interest and the corresponding subject matter.

Another example apparatus includes the foregoing components and the prioritization module is configured to establish a higher priority level for video data related to subject matter within a region of interest and establish a lower priority level for data related to subject matter within a region of non-interest. The video data processing module is configured to process video data related to subject matter corresponding to the one or more identified regions of interest and non-interest based, at least in part, on the established priority levels.

Another example apparatus includes the foregoing components and the processing of video data related to subject matter corresponding to an identified region of interest includes higher pixel sampling than processing of video data related to subject matter corresponding to an identified region of non-interest.

According to another aspect there is provided a method for adaptive video data processing of a video file. The method includes presenting, by a display, video content of a video file to at least one viewer, capturing, by a camera, at least one image of the viewer during presentation of one or more video frames of the video film, detecting, by a face detection module, a facial region in the image, identifying, by the face detection module, one or more viewer characteristics of the viewer in the image, the one or more viewer characteristics is associated with video content of the one or more video frames of the video file, receiving, by a data processing system, data related to the one or more viewer characteristics and processing, by the data processing system, video data of the video file, based, at least in part, on the data related to the one or more viewer characteristics.

Another example method includes the foregoing operations and further includes determining, by the face detection module, focus of eye gaze of the viewer relative to the display during presentation of the one or more video frames and identifying, by the face detection module, one or more regions of the display as regions of interest and one or more regions of the display as regions of non-interest based, at least in part, on the focus of eye gaze of the viewer.

Another example method includes the foregoing operations and a region of interest includes a region of the display upon which the viewer's eye gaze is focused and a region of non-interest includes of region of the display upon which the viewer's eye gaze is not focused.

Another example method includes the foregoing operations and further includes indentifying, by the data processing system, subject matter of the one or more video frames corresponding to the one or more regions of interest and the one or more regions of non-interest and establishing, by the data processing system, a priority level for each of the one or more identified regions of interest and non-interest and corresponding subject matter. The video data related to subject matter corresponding to the one or more regions of interest has a higher priority level than video data related to subject matter corresponding to the one or more regions of non-interest.

Another example method includes the foregoing operations and processing of video data of the video file includes processing video data related to subject matter corresponding to the one or more identified regions of interest and non-interest based, at least in part, on the established priority levels.

According to another aspect there is provided at least one computer accessible medium including instructions stored thereon. When executed by one or more processors, the instructions may cause a computer system to perform operations for adaptive video data processing of a video file. The operations include presenting, by a display, video content of a video file to at least one viewer, capturing, by a camera, at least one image of the viewer during presentation of one or more video frames of the video film, detecting, by a face detection module, a facial region in the image, identifying, by the face detection module, one or more viewer characteristics of the viewer in the image, the one or more viewer characteristics is associated with video content of the one or more video frames of the video file, receiving, by a data processing system, data related to the one or more viewer characteristics and processing, by the data processing system, video data of the video file, based, at least in part, on the data related to the one or more viewer characteristics.

Another example computer accessible medium includes the foregoing operations and further includes determining, by the face detection module, focus of eye gaze of the viewer relative to the display during presentation of the one or more video frames and identifying, by the face detection module, one or more regions of the display as regions of interest and one or more regions of the display as regions of non-interest based, at least in part, on the focus of eye gaze of the viewer.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1. A system for adaptive video data processing of a video file, said system comprising:
a display for displaying video content of a video file to a viewer;
a face detection module configured to detect a facial region in an image and identify one or more characteristics of said viewer in said image, said one or more viewer characteristics being associated with video content of one or more video frames of said video file during presentation to said viewer;
a data processing system configured to receive data related to said one or more viewer characteristics and adjust processing of video data of said video file based, at least in part, on said data related to said one or more viewer characteristics to generally match the viewer's perceptual needs.

2. The system of claim 1, wherein said viewer characteristics are selected from the group consisting of eye movement of said viewer relative to said display, focus of eye gaze of said viewer relative to said display and distance between said viewer and said display.

3. The system of claim 2, wherein said face detection module is configured to identify one or more regions of said display as regions of interest and one or more regions of said display as regions of non-interest based, at least in part, on said focus of eye gaze of said viewer relative to said display during presentation of said one or more video frames.

4. The system of claim 3, wherein a region of interest comprises a region of said display upon which said viewer's eye gaze is focused and a region of non-interest comprises of region of said display upon which said viewer's eye gaze is not focused.

5. The system of claim 3, wherein said data processing system comprises an interest identification module configured to indentify subject matter of said one or more video frames corresponding to said one or more regions of interest and said one or more regions of non-interest.

6. The system of claim 5, wherein said data processing system comprises a prioritization module configured to establish a priority level for each of said one or more identified regions of interest and non-interest and said corresponding subject matter.

7. The system of claim 6, wherein said prioritization module is configured to establish a higher priority level for video data related to subject matter within a region of interest and establish a lower priority level for data related to subject matter within a region of non-interest.

8. The system of claim 7, wherein said data processing system comprises a video data processing module configured to process video data related to subject matter corresponding to said one or more identified regions of interest and non-interest based, at least in part, on said established priority levels.

9. The system of claim 8, wherein processing of video data related to subject matter corresponding to an identified region of interest comprises higher pixel sampling than processing of video data related to subject matter corresponding to an identified region of non-interest.

10. The system of claim 1, wherein said data processing system is further configured to process said video data of said video file based on predetermined perceptual heuristics or video content analytics.

11. The system of claim 1, wherein processing of said video data is selected from the group consisting of compression of said video data, conversion of said video data, rendering of said video data and transformation of said video data.

12. An apparatus for adaptive video data processing of a video file for presentation to a viewer on a display, said apparatus comprising:
a video data processing module configured to receive data related to one or more characteristics of a viewer associated with video content of one or more video frames of said video file during presentation of said video file to said viewer on said display, said video data processing module configured to adjust processing of video data of said video file based, at least in part, on said data related to said one or more viewer characteristics to generally match the viewer's perceptual needs.

13. The apparatus of claim 12, wherein said viewer characteristics are selected from the group consisting of eye movement of said viewer relative to said display, focus of eye gaze of said viewer relative to said display and distance between said viewer and said display.

14. The apparatus of claim 13, wherein said viewer characteristics comprise data related to one or more regions of said display identified as being regions of interest to said viewer and one or more regions of said display identified as being regions of non-interest to said viewer, said one or more regions of interest and non-interest being based, at least in part, on said focus of said viewer's eye gaze relative to said display.

15. The apparatus of claim 14, further comprising:
an interest identification module configured to indentify subject matter of said one or more video frames corresponding to said one or more identified regions of interest and said one or more identified regions of non-interest; and
a prioritization module configured to establish a priority level for each of said one or more identified regions of interest and non-interest and said corresponding subject matter.

16. The apparatus of claim 15, wherein said prioritization module is configured to establish a higher priority level for video data related to subject matter within a region of interest and establish a lower priority level for data related to subject matter within a region of non-interest, wherein said video data processing module is configured to process video data related to subject matter corresponding to said one or more identified regions of interest and non-interest based, at least in part, on said established priority levels.

17. The apparatus of claim 16, wherein processing of video data related to subject matter corresponding to an identified region of interest comprises higher pixel sampling than processing of video data related to subject matter corresponding to an identified region of non-interest.

18. A method for adaptive video data processing of a video file, said method comprising:
presenting, by a display, video content of a video file to at least one viewer;
capturing, by a camera, at least one image of the viewer during presentation of one or more video frames of said video file;
detecting, by a face detection module, a facial region in said image;
identifying, by said face detection module, one or more viewer characteristics of said viewer in said image, said one or more viewer characteristics being associated with video content of said one or more video frames of said video file;
receiving, by a data processing system, data related to said one or more viewer characteristics; and
adjust processing, by said data processing system, of video data of said video file, based, at least in part, on said data related to said one or more viewer characteristics to generally match the viewer's perceptual needs.

19. The method of claim 18, further comprising:
determining, by said face detection module, focus of eye gaze of said viewer relative to said display during presentation of said one or more video frames; and
identifying, by said face detection module, one or more regions of said display as regions of interest and one or more regions of said display as regions of non-interest based, at least in part, on said focus of eye gaze of said viewer.

20. The method of claim 19, wherein a region of interest comprises a region of said display upon which said viewer's eye gaze is focused and a region of non-interest comprises of region of said display upon which said viewer's eye gaze is not focused.

21. The method of claim 19, further comprising:
indentifying, by said data processing system, subject matter of said one or more video frames corresponding to said one or more regions of interest and said one or more regions of non-interest; and
establishing, by said data processing system, a priority level for each of said one or more identified regions of interest and non-interest and corresponding subject matter;
wherein video data related to subject matter corresponding to said one or more regions of interest has a higher priority level than video data related to subject matter corresponding to said one or more regions of non-interest.

22. The method of claim 21, wherein said processing of video data of said video file comprises processing video data related to subject matter corresponding to said one or more identified regions of interest and non-interest based, at least in part, on said established priority levels.

23. At least one non-transitory computer accessible medium storing instructions which, when executed by a machine, cause the machine to perform operations for adaptive video data processing of a video file, said operations comprising:
presenting, by a display, video content of a video file to at least one viewer;
capturing, by a camera, at least one image of the viewer during presentation of one or more video frames of said video file;
detecting, by a face detection module, a facial region in said image;
identifying, by said face detection module, one or more viewer characteristics of said viewer in said image, said one or more viewer characteristics being associated with video content of said one or more video frames of said video file;
receiving, by a data processing system, data related to said one or more viewer characteristics; and
adjust processing, by said data processing system, of video data of said video file, based, at least in part, on said data related to said one or more viewer characteristics to generally match the viewer's perceptual needs.

24. The non-transitory computer accessible medium of claim 23, wherein said operations further comprise:
determining, by said face detection module, focus of eye gaze of said viewer relative to said display during presentation of said one or more video frames; and
identifying, by said face detection module, one or more regions of said display as regions of interest and one or more regions of said display as regions of non-interest based, at least in part, on said focus of eye gaze of said viewer.
